(19) United States
(12) Patent Application Publication
(10) Pub. No.: US 2009/0312859 A1
(43) Pub. Date: Dec. 17, 2009

(54) MODIFYING ENTRY ANGLES ASSOCIATED WITH CIRCULAR TOOLING ACTIONS TO IMPROVE THROUGHPUT IN PART MACHINING

(75) Inventor: Mehmet E. Alpay, Portland, OR (US)

Correspondence Address: YOUNG BASILE, 3001 WEST BIG BEAVER ROAD, SUITE 624, TROY, MI, 48084, US

(73) Assignee: ELECTRO SCIENTIFIC INDUSTRIES, INC., Portland, OR (US)

(21) Appl. No.: 12/483,536

(22) Filed: Jun. 12, 2009

Related U.S. Application Data
(60) Provisional application No. 61/061,692, filed on Jun. 16, 2008.

(51) Int. Cl. G05B 19/416; G05B 19/19

(52) U.S. Cl. 700/103; 700/188; 700/191

(57) ABSTRACT

An apparatus for controlling a trajectory along which a tooling positioner system moves tooling for machining multiple features of the same type in a component includes a first tooling trajectory having an entry velocity at a time when the tooling begins machining a first feature and an exit velocity at a time when the tooling completes machining of the first feature. A second tooling trajectory has an entry velocity at a time when the tooling begins machining a second feature and an exit velocity at a time when the tooling completes machining of the second feature. The entry and exit velocities of the second tooling trajectory are different from the respective entry and velocities of the first tooling trajectory. Methods for controlling a trajectory are also taught.

### CROSS REFERENCE TO RELATED APPLICATION

This application claims the benefit of U.S. provisional application No. 61/061,692, filed Jun. 16, 2008.

### FIELD OF THE INVENTION

The invention relates generally to part machining incorporating circular tooling actions.

### BACKGROUND

During machining operations, it is desirable to minimize the non-processing (so-called “dead”) time associated with movements of tooling from one machined feature to the next relative to a work piece. According to a standard approach, a total tooling move “length” associated with such moves is minimized.

### SUMMARY

Embodiments taught herein include apparatuses and methods that reduce the dead time associated with movements of tooling relative to a work piece from one machined feature to the next. According to one example, an apparatus for controlling a trajectory along which a tooling positioner system moves tooling relative to a component for machining multiple features of the same type in the component is described. A first tooling trajectory has an entry velocity at a time when the tooling begins machining a first feature and an exit velocity at a time when the tooling completes machining of the first feature. A second tooling trajectory has an entry velocity at a time when the tooling begins machining a second feature and an exit velocity at a time when the tooling completes machining of the second feature. The entry and exit velocities of the second tooling trajectory are different from the respective entry and exit velocities of the first tooling trajectory.

According to another example, a method of machining circular features in a component using tooling is described. The method includes modifying a tooling trajectory associated with machining the circular features on a per-feature basis to at least one of reduce total feature-to-feature move time and reduce amplitudes of acceleration commands associated with individual feature-to-feature moves.

Details and variations of these embodiments and others are described hereinafter with respect to the drawing figures.

### BRIEF DESCRIPTION OF THE DRAWINGS

The description herein makes reference to the accompanying drawings wherein like reference numerals refer to like parts throughout the several views, and wherein:

FIG. 1 is a simplified pictorial diagram of an example of a tooling positioner system;

FIG. 2 is a computer simulation of a first tooling trajectory corresponding to an entry angle of 0 degrees;

FIG. 3 is a computer simulation of a second tooling trajectory corresponding to an entry angle of 90 degrees;

FIG. 4 is a computer simulation of a third tooling trajectory corresponding to an entry angle of 180 degrees;

FIG. 5 is a computer simulation of a fourth tooling trajectory corresponding to an entry angle of 270 degrees;

FIG. 6 is a graph illustrating the drilling of two rows of holes over time using the same tooling trajectory with an entry angle of 90 degrees;

FIG. 7 is a graph illustrating acceleration commands for x-axis motion of a tooling positioner for the drilling of FIG. 6;

FIG. 8 is a graph illustrating the drilling of two rows of holes over time using alternating tooling trajectories with respective entry angles of 90 degrees and 270 degrees;

FIG. 9 is a graph illustrating acceleration commands for x-axis motion of a tooling positioner for the drilling of FIG. 8;

FIG. 10 is a graph comparing a standard tooling trajectory approach versus the teachings herein;

FIG. 11 is a graph illustrating the drilling of two rows of holes over time using reversed trepan tooling trajectories, both with entry angles of 90 degrees.

### DETAILED DESCRIPTION OF EMBODIMENTS OF THE INVENTION

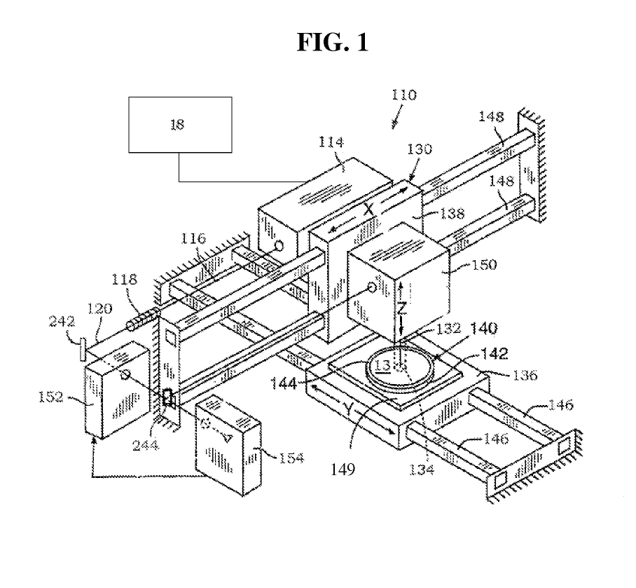

An example of a tooling positioner system shown in FIG. 1 is a laser processing system 110 utilizing a compound beam positioning system equipped with a wafer chuck assembly 140 that can be employed for ultraviolet laser ablative patterning of microstructures and other features such a blind and/through vias in a semiconductor work piece 13 such as a printed circuit board. Laser system 110 shown includes a laser 114 that provides a laser output 116 of one or more laser pulses at a predetermined wavelength and spatial mode profile.

Laser output 116 can be passed through a variety of well-known expansion and/or collimation optics 118, propagated along an optical path 120 and directed by a beam positioning system 130 to impinge laser system output pulse(s) 132 on a laser target position 134 on work piece 13. Beam positioning system 130 can include a translation stage positioner that can employ at least two transverse stages 136 and 138 that support, for example, X, Y and/or Z positioning mirrors 242 and 244. Beam positioning system 130 can permit quick movement between target positions 134 on the same or different work pieces 13.

The stages 136 and 138 can move the beam positioning system 130 along a trajectory relative to the work piece 13 for forming features in the work piece 13. As shown in the example of FIG. 1, the translation stage positioner is a split-axis system where a Y stage 136, typically moved by linear motors along rails 146, supports and moves work piece 13, and an X stage 138, typically moved by linear motors along rails 148, supports and moves a fast positioner 150 that in turn supports a focusing lens freely movable along the illustrated Z-axis according to a number of known methods.

Still referring to FIG. 1, a positioning mirror (not shown) is mounted within the housing of fast positioner 150 to direct optical path 120 along the illustrated Z-axis through the focusing lens to the laser target position 134. The Z dimension between X stage 138 and Y stage 136 may also be adjustable. Positioning mirrors 242 and 244 align optical path 120 through any turns between laser 114 and fast positioner 150, which is positioned along optical path 120. Fast positioner 150 may, for example, employ high resolution linear motors or a pair of galvanometer mirrors that can effect unique or repetitive processing operations based on provided test or design data. Stages 136 and 138 and positioner 150 can be controlled and moved independently or coordinated to move together in response to panelized or unpanelized data. Thus, in a laser processing system 110 such as the example shown in FIG. 1, the total move length can, but does not necessarily, include move lengths of both the stages 136 and 138.

Fast positioner 150 can also include a vision system that can be aligned to one or more fiducials on the surface of work piece 13. Beam positioning system 130 can employ vision or beam alignment systems that work through an objective lens or are off axis with a separate camera.

An optional laser power controller 152, such as a half wave plate polarizer, may be positioned along optical path 120. In addition, one or more beam detection devices 154, such as photodiodes, may be downstream of laser power controller 152, such as aligned with positioning mirror 244 that is adapted to be partly transmissive to the wavelength of laser output 116. Beam detection devices 154 are preferably in communication with beam diagnostic electronics that convey signals to modify the effects of laser power controller 152.

Work piece 13 is supported by chuck assembly 140, which includes a vacuum chuck base 142, a chuck top 144 and an optional plate 149. Plate 149 is easily connected to and disengaged from at least one of stages 136, 138. Base 142 may alternatively be adapted to be secured directly to stages 136 or 138.

Movement of the beam positioning system 130 along a trajectory relative to the work piece 13 can be controlled by a controller 18, which can include a processor, memory and software stored on the memory. The software can include one or more toolpath files encoding trajectories along which the controller 18 can control the translation position system to move the beam positioning system 130 relative to the work piece 13. The one or more trajectories can be stored on the memory in common file formats.

The tooling positioner system can be, as examples, laser micro-machining systems from Electro Scientific Industries, Inc. of Portland, Oreg. and sold as Model Nos. 5330, 5530, 5650 and 5800. Also, while the illustrated tooling positioning system includes beam positioning system 130 as tooling that is movable along a trajectory relative to a component, here work piece 13, it is understood that other tooling positioning systems can be used. In a system in which the work piece 13 remains stationary, for example, the total move length can be equal to the move length of the beam positioning system 130.

A standard approach for minimizing the dead time associated with tooling movements, such as movements of the beam positioning system 130 relative to the work piece 13 in the example shown in FIG. 1, is to minimize the total move length associated with tooling movements from one machined feature to the next. This approach works fine when the tooling action associated with the machining of each feature merely calls for keeping the beam positioning system 130 and other tooling stationary while machining a particular feature. In such cases, all feature-to-feature moves are simple point-to-point moves that call for zero initial and final tooling velocities, and total move length is a suitable metric to use for optimization, as it will be substantially proportional to total move time.

Furthermore, standard industry practice associates a particular tooling action with a particular feature type for a given application. Under standard industry practice, all features of the same type (e.g., of the same size and shape) in each given application are machined by making the tooling follow the same exact trajectory relative to the work piece 13. Having the tooling follow the exact same trajectory in turn will yield the use of identical entry and exit tooling velocity vectors relative to the work piece 13 for machining all features belonging to the same type.

The inventor has found, unexpectedly, that when the tooling action requires that the tooling follow a certain trajectory relative to the work piece 13 at a non-zero tooling speed, that is, when there are non-zero “entry” and “exit” tooling velocities, it is possible to reduce the non-processing time spent during feature-to-feature tooling movements by improving the alignment of the tooling velocity vectors with the feature-to-feature trajectory compared to the standard approach.

More specifically, a typical part machining application calls for replicating the tooling action associated with the formation of a feature multiple times at different locations on the work piece 13, such as drilling holes of a certain diameter at desired locations on a panel. Such features can have circular geometries (e.g., blind and through vias in PCBs or annular rings). When such circular geometries are present, it is further expected that the tooling will follow a substantially circular path on the work piece 13 that conforms to the geometry of the feature to be processed. Examples of such tooling trajectories include trepans, circles and spirals. Replicating the tooling action associated with the formation of a feature multiple times requires the tooling achieve well-defined non-zero work-surface velocities (i.e., velocities relative to the work piece 13) at the beginning and end of the tooling trajectory.

It is further customary in part machining applications to pre-define a tooling trajectory for all features of the same type. As such, it is customary that all features of the same type will require the tooling to achieve the same entry and exit velocity vectors relative to the work piece 13 regardless of where the features are located on the work piece 13 or the sequence in which the features are processed.

However, the requirement that all features of the same type be processed by the tooling following identical trajectories is unnecessarily restrictive and is likely to yield sub-optimal system performance vis-à-vis the non-processing time spent during feature-to-feature moves. Without being bound to theory, it is believed that features that have circular geometries are inherently invariant to rotational and directional changes in tooling trajectory. Accordingly, it is possible to modify the entry and exit angles associated with the tooling trajectory on a per-feature basis, such as the location of each feature or its position relative to other features, even for features of the same type. This new degree of freedom can be utilized to substantially align the entry and exit tooling velocity vectors associated with the processing of a particular feature with the move that brings the tooling to that feature from the prior feature and the move that takes the tooling away from that feature to the next feature, respectively. In other words, the entry velocity vector of the tooling associated with the processing of a particular feature can be substantially aligned with the move that brings the tooling to that feature from the prior feature. Similarly, the exit velocity vector of the tooling associated with the processing of a particular feature can be substantially aligned with the move that takes the tooling away from that feature to the next feature.

Since the tooling will thus be moving in the “right” direction when it begins and finishes the processing of each feature, such an arrangement can substantially reduce or eliminate the need for time-consuming tooling acceleration segments during feature-to-feature moves, which in turn should reduce the time spent during such moves and hence increase overall system throughput.

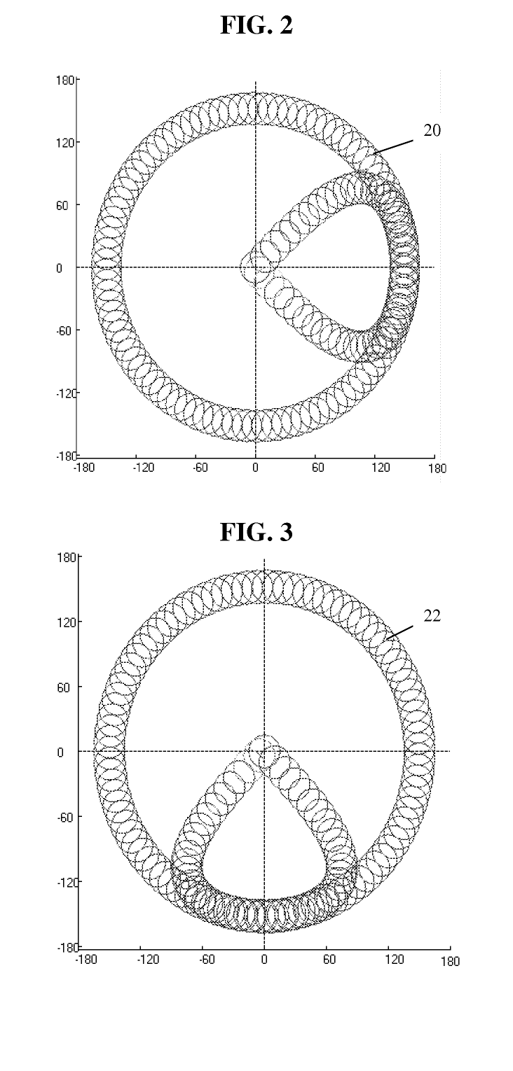

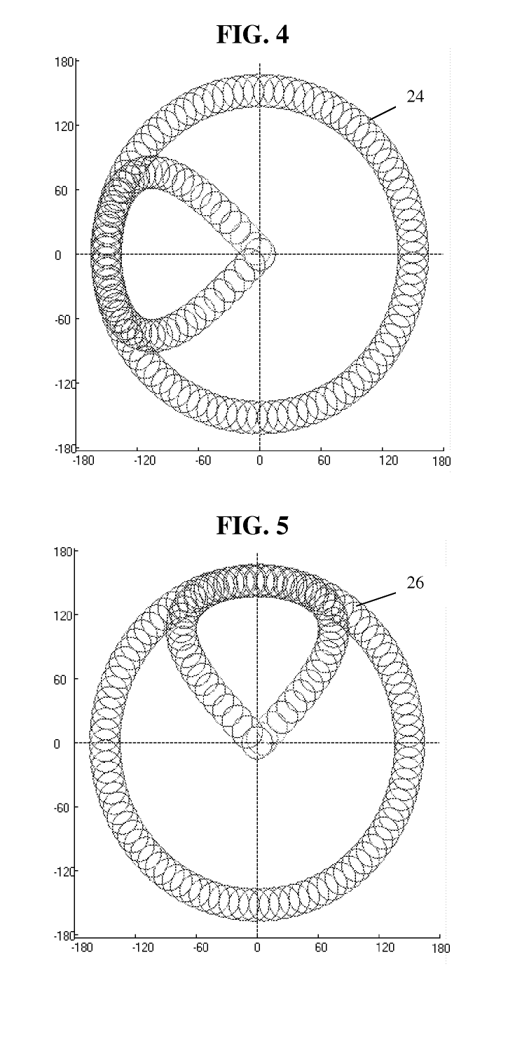

The application of these teachings is illustrated initially in FIGS. 2-7.

FIGS. 2-5 respectively show four different trepan tooling trajectories 20, 22, 24 and 26 that correspond to different pre-defined entry angles (0, 90, 180 and 270 degrees). The trajectories 20, 22, 24 and 26 define features 17 that are formed upon completion of machining and are associated with a trepan trajectory currently available in laser micro-machining systems from Electro Scientific Industries, Inc. of Portland, Oreg. and sold as Model Nos. 5330, 5530 and 5650. The illustrated trajectories 20, 22, 24 and 26 are shown by example only and do not limit application of the teachings herein.

Note that the trajectories 20, 22, 24 and 26 shown in FIGS. 2-5 are “equivalent” trajectories. That is, they can all be derived from a single “base” trajectory by rotating or taking the mirror image of the base trajectory. For example, in the four different trajectories shown in FIGS. 2-5, the 0-degree entry trajectory 20 of FIG. 2 can be considered the base trajectory. Then, the remaining three trajectories 22, 24 and 26 of FIGS. 3-5 are all equivalent trajectories to the base trajectory 20 in that the equivalent trajectories 22, 24 and 26 can obtained by rotating the base trajectory 20 by predetermined amounts (e.g., 90, 180 and 270 degrees as shown in FIGS. 2-4, respectively) or arbitrary amounts. The trajectories 20, 22, 24 and 26 form a set of predefined equivalent trajectories. The tooling can be controlled by the controller 18 to operate while moving any of the trajectories 20, 22, 24 and 26 relative to the work piece 13 to form identical features.

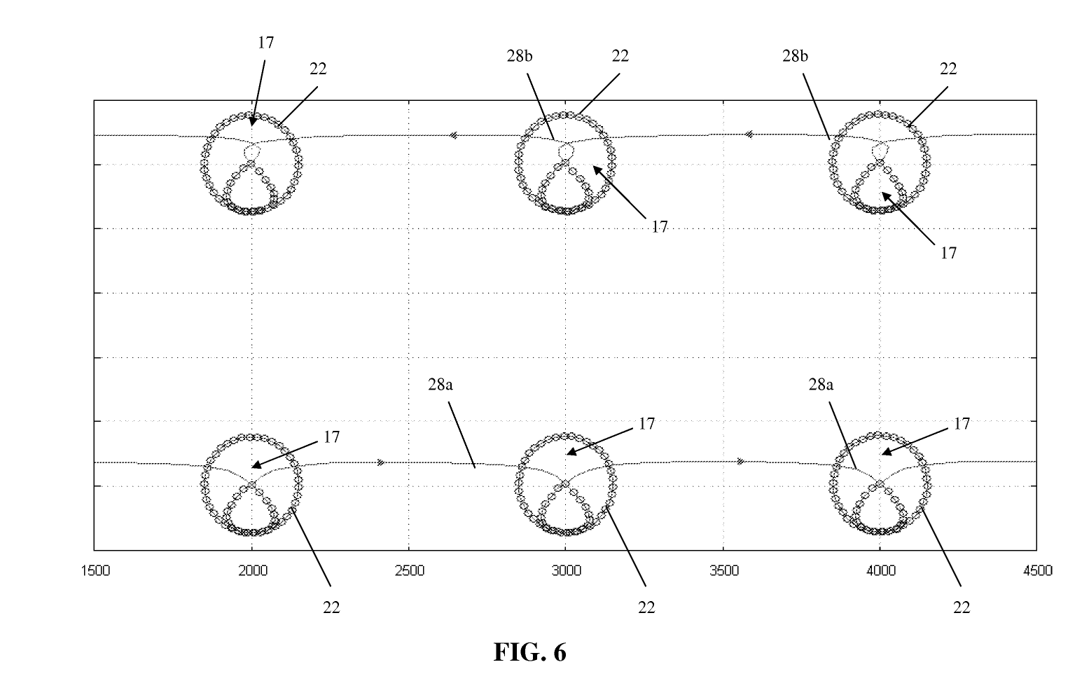

FIG. 6 shows a process sequence including tooling trajectories 22 and feature-to-feature motion trajectories 28a and 28b associated with the drilling of two rows of features 17 using the same trepan tooling trajectory 22 (entry angle=90 degrees) for each feature 17. Feature-to-feature motion trajectory 28a is the trajectory traveled by the tooling relative to the work piece 13 between tooling trajectories 22 in the bottom row as shown in FIG. 6 and feature-to-feature motion trajectory 28b is the trajectory traveled by the tooling relative to work piece 13 between tooling trajectories 22 in the top row as shown in FIG. 6. The features 17 are arranged in an array and processed in a serpentine pattern such that the bottom row is processed in a first, +x direction as shown, and then the top row is processed in a second and opposite, −x direction.

As can be seen in FIG. 6, it is notable that maintaining the same trepan tooling trajectory 22 for both rows results in misalignment between the entry and exit velocities of the tooling trajectory 22 and the feature-to-feature motion trajectory 28b while processing the top row. This misalignment results in time spent reversing the direction of the tooling before and after processing features 17 in the second row (and any subsequent even-numbered rows).

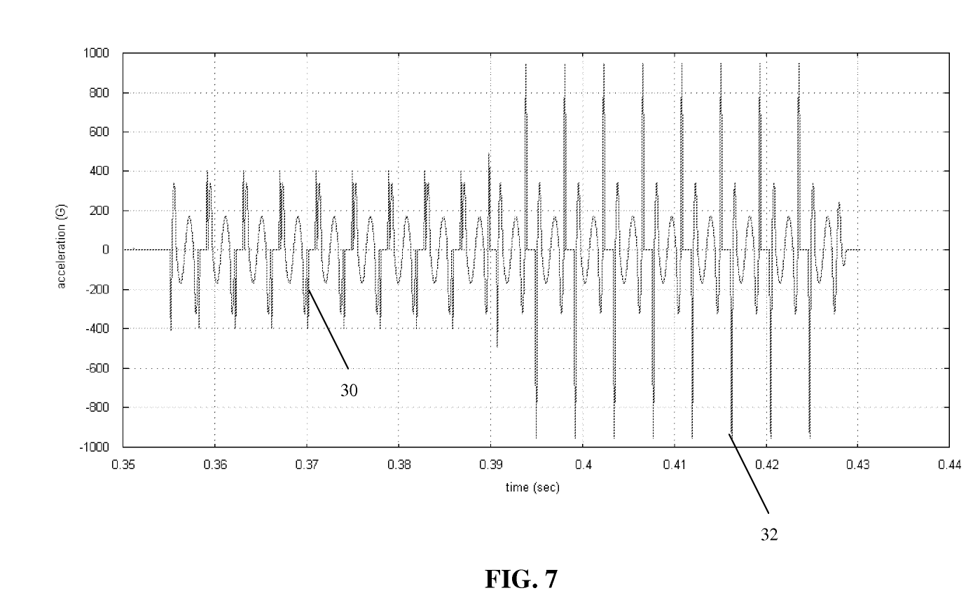

The problems associated with the processing shown in FIG. 6 are clearly seen by referring to FIG. 7, which shows the acceleration commands 30 for the x-axis motion of the beam positioning system 130 for the scenario of FIG. 6. Notable in this figure is the presence of large spikes 32 in beam positioning system 130 acceleration while processing the features 17 in the second (top) row of FIG. 6. These spikes 32 are necessary to “reverse” the exit velocity of the beam positioning system 130 for each feature 17 so as to affect the subsequent feature-to-feature move 28b.

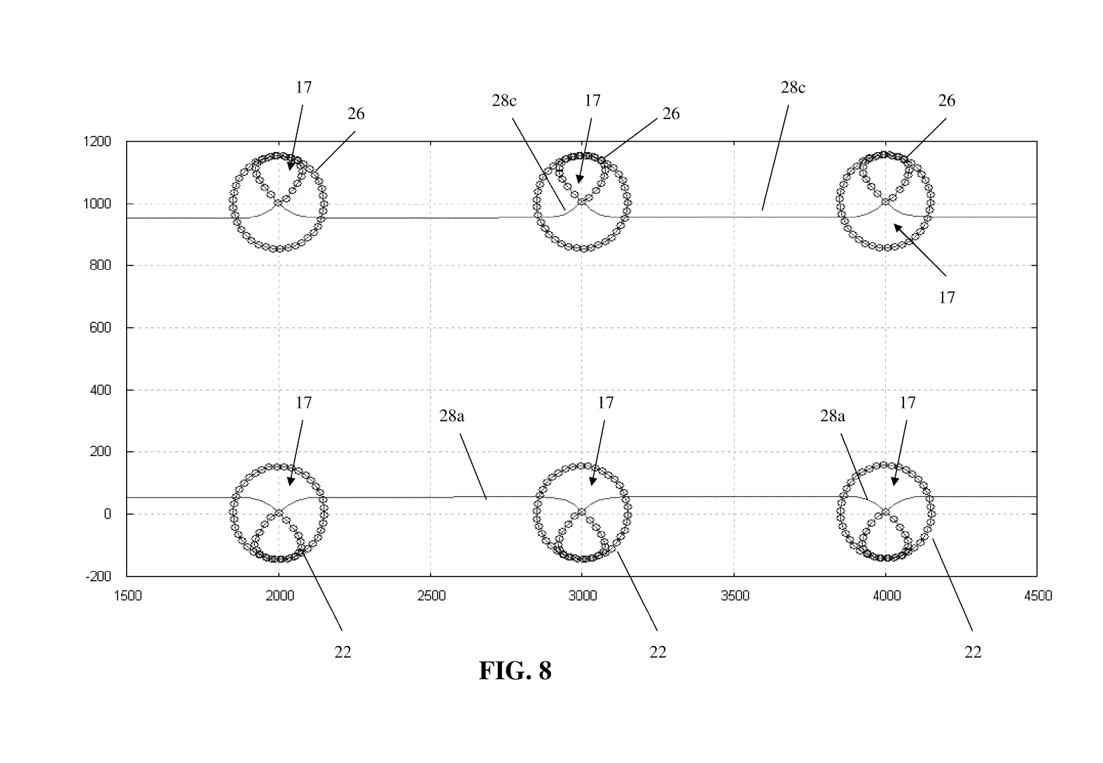

FIG. 8 shows an example of a proposed approach for machining features 17. Like FIG. 6, FIG. 8 also shows tooling trajectories 22 and feature-to-feature motion trajectories 28a for machining the lower row of features 17 in the same pattern of features 17 as in FIG. 6. However, tooling trajectories 26 and feature-to-feature motion trajectories 28d are used for machining the upper row of features 17. That is, in FIG. 8, the features 17 in the second, top row are associated with a different tooling trajectory 26 compared to those in the first row. In an array of features with more than two rows, the first and any subsequent odd-numbered rows can be considered a first category of features 17. The beam positioning system 130 continues to follow the tooling trajectory 22 having an entry angle of 90 degrees, which matches the +x direction of the feature-to-feature motion trajectory 28a, when machining features 17 in the first category. However, the second and any subsequent even-numbered rows can be considered in a second category, and the beam positioning system 130 can follow the tooling trajectory 26 having an entry angle of 270 degrees to substantially match the −x direction of the feature-to-feature motion trajectory 28c. A comparison of FIG. 8 with FIG. 6 shows that there is no longer a need to reverse the beam positioning system 130 direction while processing the features 17 of the top row. Also, features 17 can be classified in categories based on, as an additional example, the column in which the features 17 are located.

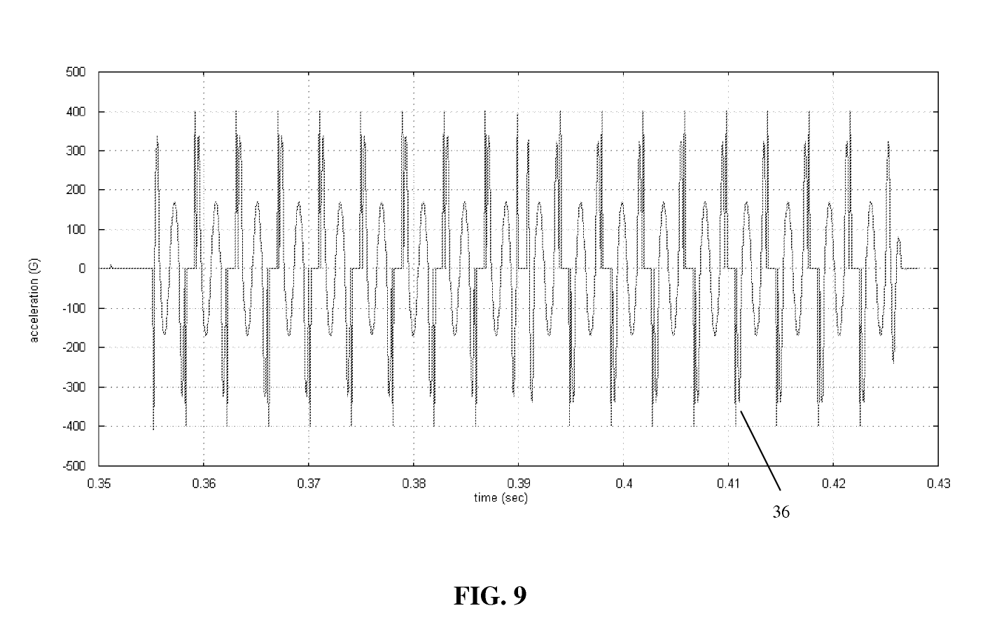

FIG. 9 confirms this result. Namely, FIG. 9 shows the position and acceleration commands 36 for the x-axis motion of the beam positioning system 130 for the scenario of FIG. 8. Comparing FIG. 9 to FIG. 7, it is clear that the sharp acceleration spikes 32 are eliminated in the acceleration commands 36 by changing the entry angles of the tooling trajectories 26.

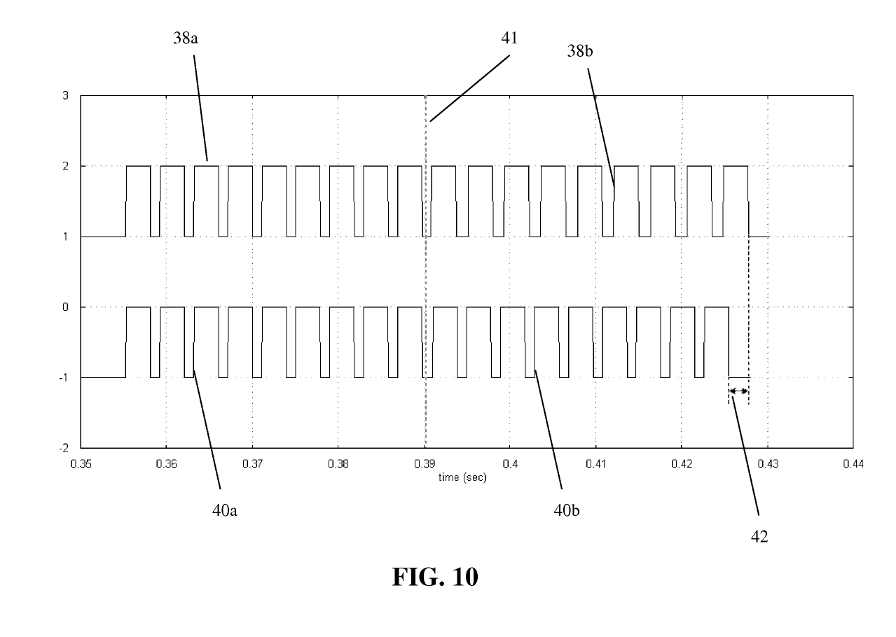

Benefits of these changes are seen in FIG. 10, which compares the laser activity of the beam positioning system 130 between the standard approach that uses a fixed tooling trajectory 22 for all features 17 as shown in FIGS. 6 and 7 and the proposed approach of FIG. 8 that uses different tooling trajectories 22 and 26 for different categories of features 17 (such as features 17 in different rows) by rotating the fundamental trajectory from tooling trajectory 22 to tooling trajectory 26 in the illustrated example. Rotating the fundamental trajectory for machining different features 17 can substantially align tooling entry/exit velocities with the overall feature-to-feature motion trajectory, such as trajectories 28a and 28c shown in FIG. 8.

Laser activity of the beam positioning system 130 using the standard approach is indicated by lines 38a and 38b for machining the bottom and top rows of features 17, respectively, as shown in FIG. 6, while the laser activity using the proposed approach is indicated by lines 40a and 40b for machining the bottom and top rows of features 17, respectively, as shown in FIG. 8. As can be seen from the comparing lines 38a and 40a of the graph of FIG. 10, the laser activities are synchronized while processing a first row of features 17 with either approach. However, after the first row of features 17 are processed at a time indicated by line 41, the laser activities are not synchronized while processing the second row of features 17 with either approach as can be seen from comparing lines 38b and 40b. Instead, when processing the second row of features 17 using the standard approach, additional time is required to move between features 17 as compared to the proposed approach. This additional time is indicated by a time savings 42 shown in FIG. 10. The entry and exit velocities of the tooling can be optimally aligned with the feature-to-feature motion trajectories 28a and 28c when, for example, the time savings 42 is maximized.

It is clear from FIG. 10 that the proposed approach has achieved a substantial reduction in total feature-to-feature move time in addition to eliminating rapid acceleration spikes 32.

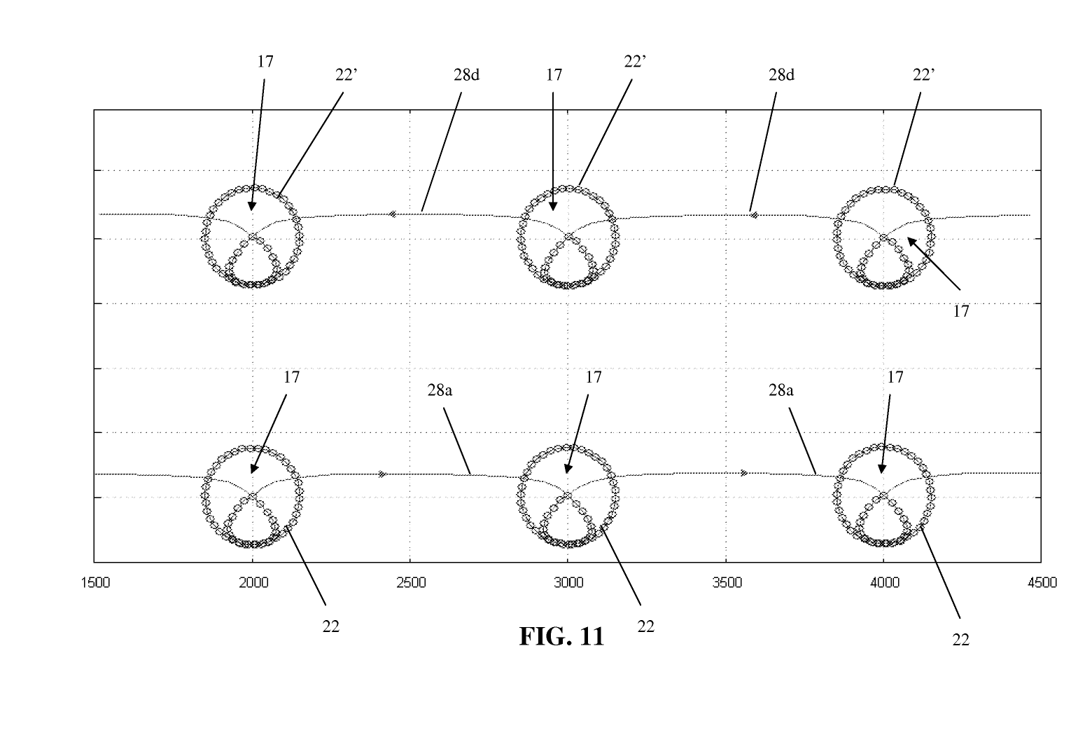

Another example of the proposed approach is illustrated in FIG. 1, which is described with reference to the same pattern of features 17 shown in FIGS. 6 and 8. However, like the inventive approach of FIG. 8, the approach of FIG. 11 can be used with a different pattern of features 17. Similar to FIGS. 6 and 8, FIG. 11 shows tooling a first trajectory section including trajectories 22 and feature-to-feature motion trajectories 28a for machining the lower row of features 17. However, a second trajectory section including tooling trajectories 22′ and feature-to-feature motion trajectories 28e can be used for machining the upper row of features 17. Tooling trajectory 22′ is the reverse trajectory of tooling trajectory 22, while feature-to-feature motion trajectory 28e is the reverse of feature-to-feature motion trajectory 28a. That is, the trajectory of the tooling, or end-effector, when machining the top row of features 17 shown in FIG. 11 identical in shape but opposite in direction compared to the trajectory of the end-effector when machining the bottom row of features 17. In this case, trajectory 22 can be considered a fundamental trajectory, as other trajectories such as trajectory 22′ have an identical shape. The proposed approach of FIG. 11 can achieve a substantial reduction in feature-to-feature move time and can eliminate rapid acceleration spikes compared to the standard approach illustrated in FIG. 6.

The ideas developed in this document have been successfully tested and observed to yield substantial improvements in feature-to-feature move times in dual-head laser micro-machining systems identified by Electro Scientific Industries as Model No. 5800. For example, for a pattern of 114 rows by 33 columns (a total of 3762 holes), move time (that is, non-processing time) for the standard approach is about 12.25 sec using a single entry angle of 90 degrees. When the tooling trajectory is modified (e.g., changed from a first trajectory used to process one feature 17 to another trajectory used to process an identical feature 17), such as by using an entry angle of 90 degrees for left-to-right rows (that is, odd-numbered rows starting from the top) and 270 degrees for right-to-left rows (that is, even-numbered rows), move time was reduced to only 6.81 sec. For each case, the laser beam tooling trajectory comprised a 2 msec dwell at the center of the hole (i.e., punch time) and a 150 mm/sec spiral operation.

The proposed approaches reduce the acceleration spikes associated with rapid directional reversals in end-effector trajectory and yields substantial reduction in total feature-to-feature move time, both of which will improve overall system performance.

The above described embodiments have been described in order to allow easy understanding of the present invention, and do not limit the present invention. On the contrary, the invention is intended to cover various modifications and equivalent arrangements included within the scope of the appended claims, which scope is to be accorded the broadest interpretation so as to encompass all such modifications and equivalent structures as is permitted under the law.

What is claimed is:

1. An apparatus for controlling a trajectory along which a tooling positioner system moves tooling relative to a component for machining multiple features of a same type in a component, the apparatus comprising:
a first tooling trajectory including an entry velocity at a time when the tooling begins machining a first feature and an exit velocity at a time when the tooling completes machining of the first feature; and
a second tooling trajectory including an entry velocity at a time when the tooling begins machining a second feature and an exit velocity at a time when the tooling completes machining of the second feature,
wherein the entry and exit velocities of the second tooling trajectory are different from the respective entry and exit velocities of the first tooling trajectory.

2. The apparatus of claim 1 wherein the second tooling trajectory is at least one of the first tooling trajectory rotated and the first tooling trajectory reversed.

3. The apparatus of claim 1 wherein the features include a first category of features and a second category of features, and wherein the apparatus further comprises:
a first feature-to-feature trajectory extending in a first direction between two of the features in the first category; and
a second feature-to-feature trajectory extending in a second direction different from the first direction between two of the features in the second category.

4. The apparatus of claim 3 wherein the entry and exit velocities of the first tooling trajectory are substantially aligned with the first direction, and wherein the entry and exit velocity of the second tooling trajectory are substantially aligned with the second direction.

5. The apparatus of claim 3 wherein the first category features and second category features are arranged in one of alternating rows and alternating columns, and wherein the second direction is opposite the first direction.

6. The apparatus of claim 3 wherein the first tooling trajectory is used to machine features in the first category and the second tooling trajectory is used to machine features in the second category.

7. A method of machining circular features in a component using tooling, comprising:
modifying a tooling trajectory associated with machining of the circular features on a per-feature basis to at least one of reduce a total feature-to-feature move time and reduce amplitudes of acceleration commands associated with individual feature-to-feature moves.

8. The method of claim 9 wherein modifying the tooling trajectory comprises:
choosing a respective tooling trajectory from among a set of pre-defined equivalent trajectories for each feature.

9. The method of claim 8 wherein choosing the respective tooling trajectory from among the set of pre-defined trajectories for each feature comprises:
choosing the respective tooling trajectory for a respective feature in such a way as to optimally align entry and exit velocity vectors for the respective feature with a feature-to-feature move that brings the tooling to the respective feature from a previous feature in a process sequence and a feature-to-feature move that takes away the tooling from the respective feature to a next feature in the process sequence, respectively.

10. The method of claim 7 wherein modifying the tooling trajectory comprises:
rotating a fundamental tooling trajectory by an arbitrary angle.

11. The method of claim 10 wherein rotating the fundamental tooling trajectory by an arbitrary angle comprises:
rotating the fundamental tooling trajectory for a respective feature in such a way as to optimally align entry and exit velocity vectors for the respective feature with a feature-to-feature move that brings the tooling to the respective feature from a previous feature in a process sequence and a feature-to-feature move that takes away the tooling from the respective feature to a next feature in the process sequence, respectively.

12. The method of claim 10 wherein rotating the fundamental tooling trajectory by an arbitrary angle comprises:
rotating the fundamental tooling trajectory by one of 90 degrees, 180 degrees and 270 degrees.

13. The method of claim 12 wherein the fundamental tooling trajectory is a trepan tooling trajectory.

14. The method of claim 7 wherein modifying the tooling trajectory comprises:
reversing a direction of motion associated with a fundamental tooling trajectory.
